(19) United States
(12) Patent Application Publication
(10) Pub. No.: US 2005/0280766 A1
(43) Pub. Date: Dec. 22, 2005

(54) Display device

(75) Inventors: Mark Thomas Johnson, Eindhoven (NL); Peter Van De Weijer, Eindhoven (NL); Johannes Nicolaas Huiberts, Eindhoven (NL); Coen Theodorus Hubertus Fransiscus Liedenbaum, Eindhoven (NL); Olaf Gielkens, Eindhoven (NL); Eric Alexander Meulenkamp, Eindhoven (NL); Simone Irene Elisabeth Vulto, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninkiljke phillips electronics nv

(21) Appl. No.: 10/527,871

(22) PCT Filed: Aug. 6, 2003
(86) PCT No.: PCT/IB03/03511

§ 371 Date: Mar. 16, 2005

(51) Int. Cl. G09G 3/34

(52) U.S. Cl. 349/167; 345/84

(57) ABSTRACT

The invention relates to a display device for displaying an image comprising a plurality of display pixels (2), a controller (3) for generating a driving signal (8) for driving the pixels (2), and sensors (9; 11; 14), wherein the sensors (9; 11; 14) are able to monitor operating conditions of the pixels (2), and the controller (3) is adapted to receive data related to the operating conditions from the sensors (9; 11; 14) to determine a brightness change of the pixels (2) caused by the operating conditions and to generate the driving signal (8) in dependence on the brightness change.

The invention relates to a display device for displaying an image comprising a plurality of display pixels, a controller for generating a driving signal for driving the pixels, and sensors. The invention also relates to a method of generating a driving signal for driving a plurality of pixels of an organic electroluminescent display device for displaying an image.

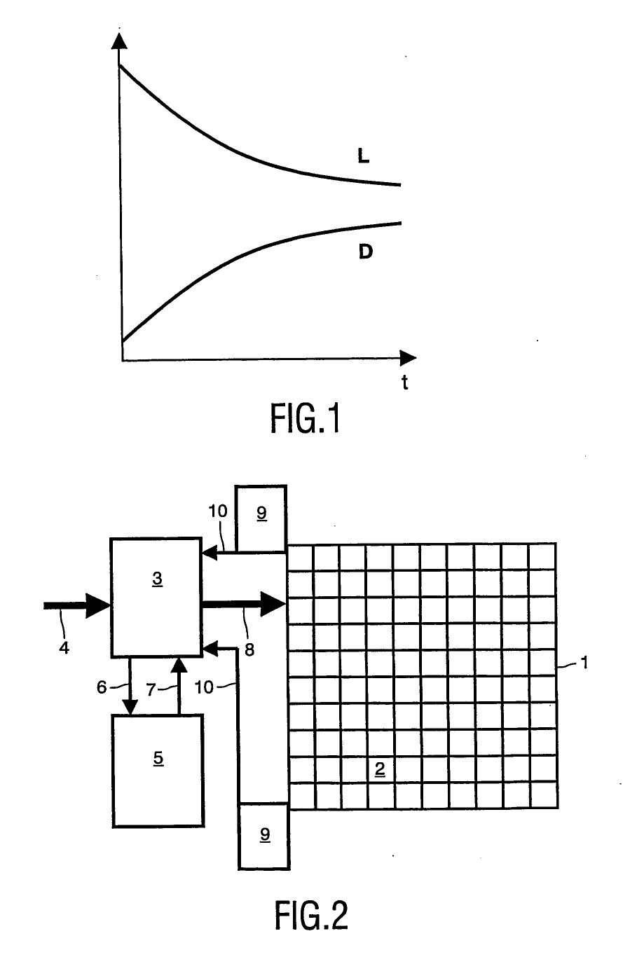

The display pixels in organic electroluminescent display devices such as poly-or or organic light emitting diode (PLED and OLED respectively) display devices, hereinafter referred to as display devices, degrade during operation, resulting in a change (usually a reduction) in light output at a given current density. An example of such degradation behavior is illustrated in FIG. 1, showing a reduction of light output L as a function of the operation time t. The display is driven at a constant current. As the light output L decreases, the driving voltage D increases. As some pixels in a display are used more often than other pixels, these more frequently used pixels exhibit a larger degradation than pixels that have been used less frequently. This phenomenon results in a burnt-in image in the display device. In color displays, the effects are even more serious as the display suffers from discoloration, i.e. “white” is no longer white, but exhibits e.g. a green shade.

WO 99/41732 discloses a tiled electronic display structure wherein each tile comprises an integrated circuit connected to the various display pixels of that tile. The integrated circuit includes an electronic compensation system which continuously adjusts the brightness of the individual display pixels to compensate for aging or degradation. The electronic compensation is achieved by predicting the decay in the brightness of the display pixel by measuring the current and time for that particular pixel and integrating the product of current and time, i.e. the total charge data This product is fitted to a characteristic curve and used to adjust the drive current by predicting a new drive current which restores the original brightness level of the pixel.

However, monitoring the total charge data for a display pixel in many instances is insufficient to reliably establish the required compensation for restoring the original brightness level of the display pixel or to maintain a uniform brightness.

It is an object of the invention to provide an improved display device that is able to maintain a more uniform brightness level of the display pixels. The invention is defined by the independent claims. The dependent claims define advantageous embodiments.

This object is achieved by providing a display device wherein the sensors are able to monitor operating conditions of the pixels and the controller is adapted to receive data related to the operating conditions from the sensors to determine a brightness change of the pixels caused by the operating conditions and to generate the driving signal in dependence on the brightness change.

By providing such a display device the data from the sensors (or sensor) are available in order to generate a driving signal for the display pixels that sufficiently takes into account relevant factors contributing to the degradation of the display pixels. This enables a more accurate determination of the brightness change of the pixels than the prior art.

It is advantageous if the controller is able to provide the pixels with a substantially constant relative brightness when the image is displayed. The relative brightness of the pixels could be used to adjust the driving signal to the level of the pixel with the worst degradation by reducing the drive of the less degraded pixels. This extends the lifetime of the pixels. Pixels with a value beyond a predetermined level of degradation could be excluded from the selection of the worst degraded pixel. Alternatively the relative brightness can be used to adapt the driving signal to restore the initial brightness level or to restore a level in-between the initial level and the level of the worst degraded pixel.

In a preferred embodiment of the invention the sensors comprise at least one temperature sensor for monitoring temperature data relating to the pixels; monitoring means are present for monitoring total charge data of the pixels and the controller is adapted to generate the driving signal in dependence on the total charge data and the temperature data. This embodiment enables adjustment of the driving signal if the operating temperature varies as a result of which the degradation behavior of the display pixels changes. The temperature data may be expressed as an acceleration factor that is used as a multiplier for the total charge to obtain the improved driving signal to provide the pixels with a substantially constant relative brightness.

It is advantageous if the temperature sensor comprises at least one reference pixel and temperature determination means adapted to determine a temperature in dependence on at least one temperature-dependent characteristic of the reference pixel. The reference pixel used for measuring or deriving the temperature is manufactured at the display device simultaneously with the display pixels, so no additional process steps have to be carried out for providing the temperature sensor. Moreover, the temperature of the display or display pixels may be measured or derived more reliably than when a different construction of a sensor is applied, since the reference pixel(s) used for temperature sensing is(are) an integral part of the display device, so a direct measurement can be performed. The temperature-dependent characteristic or value may relate to an electrical characteristic or value, such as the conductivity of the reference pixel.

Preferably, the material composition of the reference pixel is similar to that of the display pixel, since this is advantageous with regard to decreased complexity of the manufacturing process of the display device.

In a preferred embodiment of the invention, the reference pixel is driven in accordance with a temperature measurement state. In the temperature measurement state the reference pixel is biased at a level low enough to prevent, or at least substantially prevent, the pixel from emitting light and high enough to enable a reliable measurement or derivation of the temperature-dependent characteristic or value of the reference pixel. Biasing the reference pixels in accordance with the temperature measurement state has the advantage that the pixels do not exhibit degradation behavior that is usually observed when pixels are driven to emit light. Therefore, measurement of the temperature can be performed reliably and no correction is needed to account for the degradation of the reference pixel. In biasing the reference pixels, both reverse and forward bias may be employed. The reference pixel can also be regularly probed, depending e.g. on the correction driving scheme applied. Regular probing may be more efficient with regard to power consumption as compared to a continuous measurement.

In a preferred embodiment of the invention, the reference pixel is shielded from ambient or environmental light. Shielding of the reference pixel(s) from ambient light prevents photocurrents from influencing the measurement and prevents possible degradation of the reference pixel(s) due to ambient light.

In a preferred embodiment of the invention, the sensors comprise at least one reference pixel, e.g. a dummy pixel, monitoring means are present for monitoring total charge data of the pixels and further monitoring means are present, adapted for determining degradation state data of the reference pixel, the controller being adapted to generate the driving signal taking account of the total charge data and the degradation state data The incorporation of one or more reference pixels in the display device enables adjustment of the driving signal taking into account other effects, such as spontaneous degradation of display pixels (shelf life effect) and deviations from the expected degradation behavior of the display pixel especially occurring at the beginning of the life time of the display device (initial drop effect). Preferably a reference pixel has an associated photodiode for directly measuring the degradation state or for deriving a degradation state of the reference pixel.

In a preferred embodiment of the invention, the driving signal takes into account the total charge data from the monitoring means and the temperature data and the degradation state data from the further monitoring means. This enables the device to more reliably monitor the degradation of the display pixels and to generate an improved driving signal to restore the original brightness level of the display pixel.

In a preferred embodiment of the invention, the display is a color display wherein the pixels comprise at least two sub-pixels of a different type and at least one reference pixel for each type is present. Advantages of this embodiment reside in that degradation behavior of, for example, R, G and B display sub-pixels of a different type could differ significantly from each other as a consequence of which the adjustment of the driving signal is different for the R, G and B sub-pixels. Moreover, this embodiment enables the display device to maintain the required color balance. Furthermore, active matrix color displays can be monitored easily in this way since the voltage across the pixels in the array does not have to be measured anymore in order to obtain total charge data of these pixels. If dummy pixels are applied, each different type preferably is represented by a minimum of one dummy pixel. It is noted that if color displays are discussed in this application, the term “display pixel” also refers to each of the individual R, G and B sub-pixels.

In a preferred embodiment of the invention, the dummy pixels are driven at an average brightness level for each color. This embodiment eliminates the need to pre-age the displays prior to customer delivery and thereby decreases the manufacturing costs.

In a preferred embodiment of the invention, it is possible to turn off the adjustment of the driving signal due to data received from the monitoring means and/or further monitoring means for one or more color display pixels. This provides an advantage in that if serious deviations from the expected degradation behavior are encountered, extreme over-compensation, that may lead to early failure of the display, can be avoided.

It will be appreciated that the previous embodiments or aspects of the previous embodiments of the invention can be combined.

In the embodiments described above the data or derivatives thereof are stored for preferably each individual display pixel. As a further embodiment the sensors comprise circuitry to sense a relation between a reverse current and a reverse voltage of the pixels for deriving degradation state data for the pixels, and the controller is adapted to generate the driving signal taking account of the degradation state data. This embodiment has the advantage that storage of a pixel history in a memory is no longer required, since the actual degradation state of a pixel is derived from sensing the relationship between reverse voltage and reverse current. The applied reverse current or reverse voltage is preferably chosen in accordance with the size of the display pixel.

In a preferred embodiment, the degradation state data are derived after turning on the display device. In this way an absolute determination of degradation state is available at each turn on. This may be especially important if the required adjustment of the driving signal is not linear in time.

The embodiments of the invention will be described in more detail below with reference to the attached drawings, in which:

FIG. 1 schematically shows a typical degradation behavior of a LED device driven at a constant current;

FIG. 2 shows a LED display device according to a first embodiment of the invention;

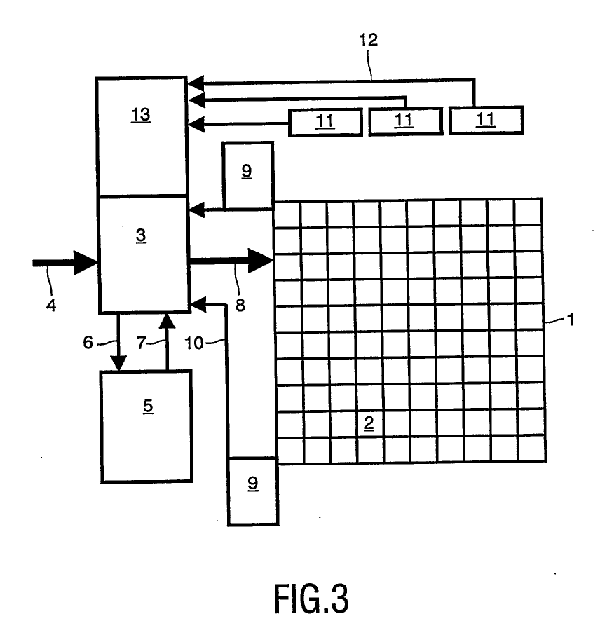

FIG. 3 shows a LED display device according to a second embodiment of the invention;

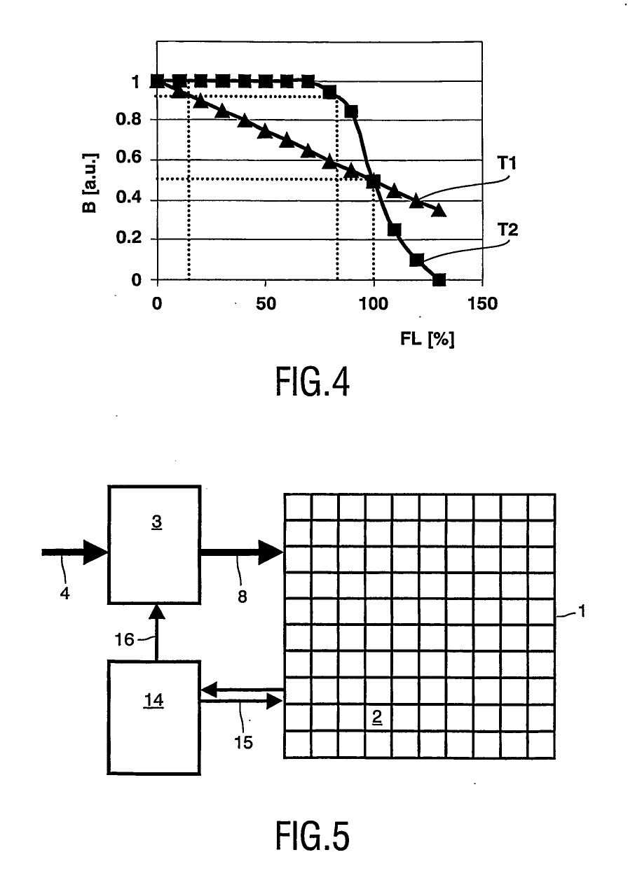

FIG. 4 is a schematic representation of the brightness decay as a function of the fractional lifetime for two types of LED display devices;

FIG. 5 shows a LED display device according to an alternative embodiment of the invention;

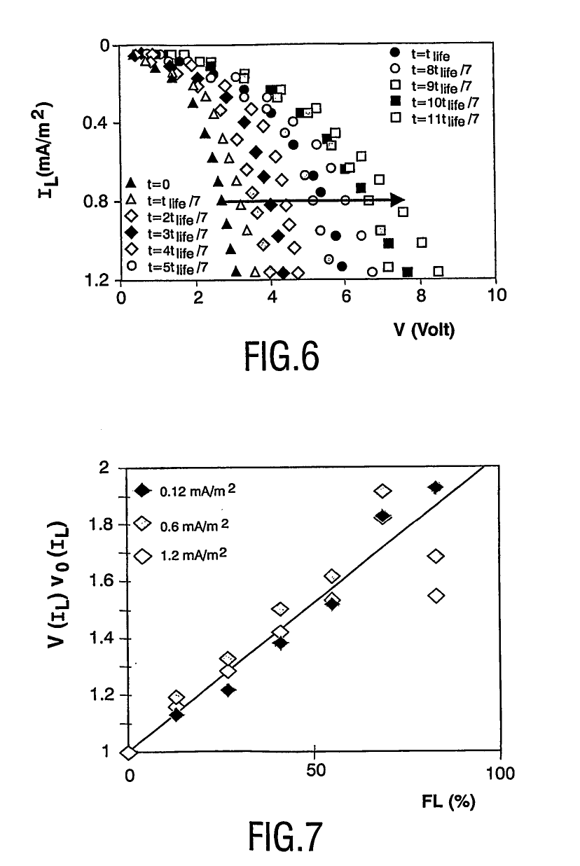

FIG. 6 shows a measurement result of the leakage current as a function of an applied reverse voltage at different lifetimes of a LED display device;

FIG. 7 shows the shift in the normalized reverse voltage as a function of the lifetime of the LED display device at different leakage currents;

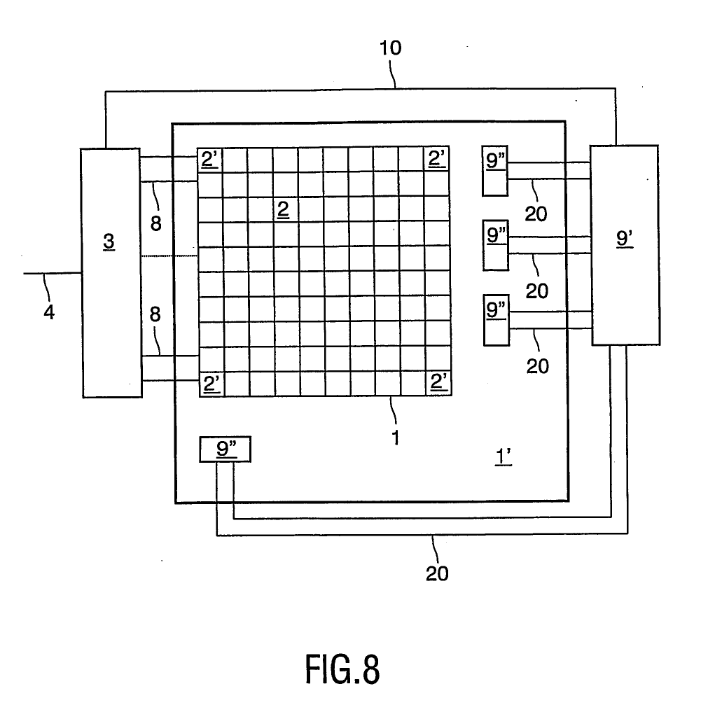

FIG. 8 shows a LED display device according to an embodiment of the invention; and

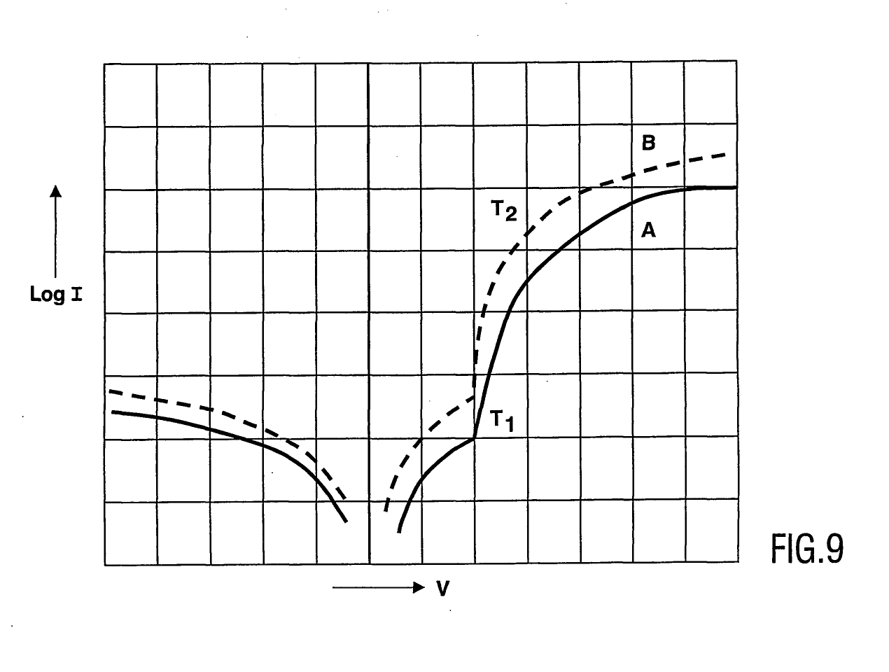

FIG. 9 shows a schematic representation of a typical current/voltage characteristic of a PLED device.

FIG. 2 shows a display device according to a preferred embodiment of the first invention wherein means are provided to compensate for the degradation behavior of a LED device as depicted in FIG. 1. A display I comprises a plurality of display pixels 2 arranged in a matrix of rows and columns. The display pixels 2 can be driven by a controller 3 in response to a data input signal 4. The data input signal 4 comprises e.g. one or more images to be shown on the display 1 by driving the individual display pixels 2. It will be appreciated that the display 1 may be a passive or an active matrix display and may be either a monochrome display or a color display in which the display pixels comprise sub-pixels, for example, R, G and B.

At a given temperature the rate of light degradation for the pixels 2 in the display 1 scales fairly linearly with the current density in the device, whilst the overall degradation rate decreases (often logarithmically) as the device is used more (FIG. 1). For color displays using different types of light emitting materials for each color, e.g. R. G and B, the absolute rate of decay of the light output varies for the different sub-pixels R, G and B.

In order to monitor this degradation, the display 1 incorporates a module 5 connected to the controller 3 by a connection 6. The module 5 is adapted to monitor the total charge which has passed through a pixel 2 at a given time, i.e. the pixel history. It is to be noted that the module 5 may be an integral part of the controller 3, but will be drawn separately for reasons of clarity. The module 5 comprises a look-up table (not shown) and/or an analytical function and is suited to provide the controller 3 via a connection 7 with data concerning the degradation of the display pixels. In color displays a separate look-up table or analytical function can be used for each sub-pixel. The controller 3 drives the display pixels 2 by generating a driving signal 8 that may be adjusted to compensate for the monitored degradation of one or more display pixels 2.

During operation, the controller 3 receives a data input signal 4 to be displayed on the display 1 by driving the display pixels 2. Data manipulation may be performed by or in the controller 3 or by or in the module 5. If a fall image of data is to be adjusted simultaneously, the data may be stored locally in the controller 3 in a simple frame memory. Alternatively, if smaller portions of image data are to be modified, a correspondingly smaller memory may be sufficient, such as a line memory. In module 5, the pixel history of a display pixel 2 is accessed and transferred to controller 3 via connection 7. In controller 3, with the help of the look-up table or analytical function, the data input signal 4 temporarily stored in the local memory of the controller 3 is adjusted to data signal 4′ (not shown) to account for the pixel history. The adjusted data signal 4′ is transferred to module 5 via connection 6 and is added to the previous pixel history and stored in module 5 as the new pixel history. Data signal 4′ is also used as the adjusted driving signal 8 for driving the display pixels 2 so as to maintain the relative brightness level of the pixels 2.

Alternatively, the data 4 of the input signal 4 to be displayed on the pixels 2 is directly transferred to module 5 via connection 6. If a full image of data is to be adjusted simultaneously, the data may be stored locally in module 5 in a simple frame memory. If smaller portions of image data are to be modified, a correspondingly smaller memory will be sufficient. In module 5, the pixel history of the pixels 2 is accessed and with the help of the look-up table or analytical function the data input signal 4 is adjusted to data signal 4′ to account for the pixel history. The adjusted data signal 4′ is added to the previous pixel history and stored in module 5 as the new pixel history. Data signal 4′ is also transferred to module 3 using connection 7 in order to obtain the adjusted driving signal 8 for driving the display pixels 2 so as to maintain the same relative brightness level. Alternatively, the brightness of less degraded display pixels can be reduced by adjusting the driving signal 8 to that of the most degraded display pixels 2 in order to prolong the display lifetime.

For color display sub-pixels not only the degradation of each pixel needs to be monitored, but also the color balance must be maintained by adjusting the driving signal, i.e. brightening (or dimming) sub-pixels of different colors in such a manner that the color balance is maintained. This adjustment can be done with regard to the brightness of a non-degraded pixel or the most degraded display pixel, or, according to an alternative scheme, with regard to, for example, a level in between the two mentioned brightness levels.

Often the degradation rate of the display pixels 2 decreases as the pixels become older, as shown in FIG. 1. Therefore, progressively fewer data from the monitoring means might be stored in the memory of the module 5 while maintaining a certain level of precision.

The display device described so far may maintain a sufficiently stable brightness if the device operates in a very small temperature range or the degradation of the display pixels 2 is not strongly temperature-dependent. However, in many instances LEDs degrade faster at higher temperatures. For obtaining reliable degradation data for the display pixels 2, it can be essential to take the operating temperature of the display pixels 2 into account. In order to obtain data concerning the operating temperature of the display pixels 2, the display device incorporates at least one temperature sensor 9. For larger displays 1 more temperature sensors 9 may be required to account for temperature gradients across the display 1. The temperature sensors 9 are connected to the controller 3 by connections 10.

In operation, the temperature of the display pixels 2 is monitored by the temperature sensors 9 and the temperature data are fed through connections 10 to the controller 3. The temperature data are used to determine an acceleration factor which may be different for each type of color sub-pixels, for example, R, G, B in a color display device. The acceleration factor reflects the different rate of degradation at each temperature, which degradation rate is known (for each color). The data are adjusted as described previously, again by using e.g. look-up tables or analytical functions in the module 5. The look-up tables or analytical functions may be modified for the operating temperature obtained from the temperature sensors 9. This ensures a temperature-independent display brightness and maintenance of a proper color balance in color displays. After calculation of the associated fall in light efficiency, the adjusted data signal 4′ is sent to the controller 3 via connection 7 and the drive signal 8 is adjusted to maintain the relative brightness level of the display pixels 2. The drive signal 8 thus is adjusted by taking into account the drive signal pixel history (by monitoring the total charge data). The pixel history is updated by adding the product of the adjusted data signal 4′ and the temperature-dependent degradation acceleration factor to the previous pixel history to be stored in module 5 as a new pixel history. In color displays the color balance may again be maintained as described previously.

In the previous embodiment as shown in FIG. 2, it was assumed that the pixel history and the temperature history of the (colored) display pixels 2 is completely reproducible. However, several situations might be encountered wherein this assumption is not valid. It is e.g. known from experience that display pixels 2 might also degrade without being driven by a driving signal 8. This effect will hereinafter be referred to as the shelf life effect. Moreover, there are periods in the degradation, especially at the start of the lifetime of the display 1, where the degradation occurs rapidly and in a less well-defined manner, hereinafter referred to as the initial drop effect.

To account for the shelf life effect, the initial drop effect and other effects, in FIG. 3 a display device is shown that incorporates reference pixels 11, hereinafter also referred to as “dummy” pixels. Reference numerals identical to those used in FIG. 2 indicate the same or similar elements. The number of dummy pixels 11 is preferably small, with a minimum of one dummy pixel 11 for each different type of sub-pixel if a color display device is used. In case two different colors are generated with the same type of sub-pixels in combination with different color filters for the sub-pixels, then for those two sub-pixels of the same type only one common reference pixel could be used. Connections 12 are used to attach the dummy pixels 11 via further monitoring units 13, such as light, voltage or current measurement facilities to the controller 3 so as to monitor either light output, voltage (at a given current) or current (at a given voltage) of the dummy pixels 11. The light measurement X could be facilitated by providing each of the dummy pixels with an associated photodiode (not shown). This photodiode can be integrated in the active matrix display during processing. In this way, the degradation state of the dummy pixels can either be directly measured (light) or derived (from the relationship between voltage increase and light decrease, as shown in FIG. 1).

In operation, the dummy pixels 11 can be used in several modes. In order to take into account the shelf life effect, one or more of the dummy pixels 11 remain essentially undriven, being only periodically probed by further monitoring unit 13 to establish the degradation state of the dummy pixel 11. As the probe period is short, this should not influence the shelf life type of degradation. If degradation due to shelf life is detected, the degradation state data must be taken into account by adjusting the pixel history in module 5 in an appropriate manner (i.e. by over-ageing all the display pixels 2) and thus adjusting the driving signal 8 to maintain the relative brightness level of the display pixels 2.

In order to monitor that the pixel degradation is proceeding as expected from the degradation model presented above, one or more of the dummy pixels 11 (of each color) may be driven by the unit 13 (not shown). Preferably, these dummy pixels 11 may be driven so as to obtain an average brightness level of each colored sub-pixel on the display 1. The monitored degradation state data can be used to adjust the pixel history in the module 5 if strong deviations from expected behavior are found and the controller 3 may generate an adjusted driving signal. This may make it possible to also compensate for degradation during the “initial drop” period, where degradation is less predictable. This could be an important advantage, as it could eliminate the need to pre-age the displays prior to customer delivery, thereby increasing lifetime and reducing manufacturing time and costs.

In extreme situations, where serious deviations from the expected degradation behavior are encountered (e.g. degradation proceeds much more slowly than expected), means (not shown) are provided making it possible to turn off the module 5 and thereby the compensation for one or more colored display pixels 2. This will avoid any run-away behavior by extreme overcompensation, which could lead to unnecessary early failure of the display.

Next, an alternative embodiment is discussed with reference to FIGS. 4-7 for improving the lifetime of an organic electroluminescent device. In FIG. 4 a schematic representation is shown of the brightness B decay for two types T1 and T2 of polymers used for a display 1 or a display pixel 2 as a function of the fractional lifetime FL. Fractional lifetime is defined as the time of operation divided by the lifetime for that particular device, wherein the lifetime is defined by the standard lifetime definition as the time in which the light output of the display 1 or display pixel 2 decays by 50% compared to the initial value. For matrix display applications a decay of only 10% may be allowed. So, especially for the type T1 behavior of the display 1 or display pixel 2, adjustment of the driving signal is important. Type I behavior is observed for PPV-type conjugated polymers, having phenyl rings and vinyl bonds, whereas the type T2 behavior is found for fluorine-type conjugated polymers having only phenyl rings. It can be observed (indicated by the dotted lines in FIG. 4) that according to the 10% decay definition for matrix display applications the life time of display pixels using type T1 polymers is five to ten times less than for type T2 polymers. According to the standard lifetime definition (allowing a decay of 50%) this difference would be only 10%. Especially type T1 polymers employed in display devices introduce severe problems with regard to a uniform brightness over the display 1. These problems relate to the fact that a variation in brightness between display pixels 2 is obtained if these pixels are driven for different amounts of time. Above, various embodiments have been described that account for this behavior and maintain the relative brightness of the display pixels 2, using a memory in module 5.

In the alternative embodiment of the invention shown in FIG. 5, the memory in the module 5 as described above with regard to the pixel history is not required to restore the original brightness level. Again, a display 1 comprises a plurality of display pixels 2 arranged in a matrix of rows and columns. The display pixels 2 can be driven by a controller 3 in response to a data input signal 4. The data input signal 4 comprises e.g. one or more images to be shown on the display 1 by driving the individual display pixels 2. It will be appreciated that the display 1 may be a passive or an active matrix display and may be either a monochrome display or a color display in which the display pixels comprise sub-pixels, for example, R, G and B. Circuitry 14 is provided for applying a reverse current or reverse voltage to one or more of the display pixels 2 and for measuring a resulting voltage or leakage current. Connection 15 allows transmission of the signals required. Circuitry 14 further is adapted to deduce from the measurement results, the degradation state data of the display pixel 2. The degradation state data thus obtained are input to the controller 3 via connection 16, enabling controller 3 to generate a driving signal 8 for the display pixel 2 taking account of the degradation state data. It will be appreciated that circuitry 14 may be a module of e.g. the controller 3 instead of being a separate entity.

FIG. 6 schematically shows the typical shift of the leakage current I_{L} during lifetime t_{life}, as indicated by the arrow, if a reverse voltage is applied. The time is indicated in terms of the lifetime. Measurements have been performed here under accelerated degradation conditions (90° C.; lifetime of 168 hours at 50 Cd/m²). At room temperature the corresponding lifetime amounts to approximately 22000 hours. From FIG. 6, it is clear that by applying a reverse voltage V and measuring a leakage current I_{L}, or vice versa, the time t during which a display pixel 2 is driven can be determined.

FIG. 7 shows such a result for display pixels 2 if a reverse current I_{L} is applied and a reverse voltage V is measured and linked to the fractional lifetime FL. The different symbols constitute the shift of the reverse voltage at three different reverse current densities. A linear behavior is found for the voltage shift as shown by the line in FIG. 7 (deviation from this linear behavior is a precursor for failure of the display pixel 2). The measured voltage V is normalized to the initial value V₀ for the reverse voltage. Since the devices can be made in a reproducible way, this initial value V₀ of the reverse voltage V is a constant.

In the alternative embodiment shown in FIG. 5, a specific reverse current I_{L} is applied by the circuitry 14 to preferably each display pixel 2 and the voltage V is measured. The applied reverse current I_{L} suitable for performing this function scales with the size of the display pixels 2. The application of the reverse current I_{L} to the display pixels 2 may be executed e.g. once a day when turning on the display device. As a result, for each pixel a reverse voltage V is obtained, which reverse voltage can be directly linked to the time t the display pixels 2 have operated (see FIG. 7). This time is directly linked to a brightness B, using the behavior of the display pixels 2 shown in FIG. 4, which corresponds to a degradation state from which the adjustment on the data input signal 4 can be deduced in order to maintain the relative brightness level of the display pixels 2 or to restore the original brightness level. So, the adjustment of the driving signal 8 can be done on the basis of the functional dependence between the measured reverse voltage V and the corresponding required correction of the display input signal 4, which is the same for all display pixels 2. A memory for the pixel history is not required. For display pixels 2 that show a large variation in properties or quality, a memory may be needed for the initial voltage V₀. Data relating to this degradation state are transmitted to the controller 3 via connection 16. The controller 3 may generate a driving signal 8, taking account of the degradation state data thus obtained, as a result of which the original brightness is corrected, restored or maintained at least partially.

In FIG. 8 an embodiment of the temperature sensor is shown wherein the display device comprises an active display area, hereinafter referred to as display, with display pixels 2 arranged in a matrix of rows and columns. A possible configuration as used in PLED displays is that of a display pixel 2 or segment comprising a layer of electroluminescent material with an active layer of organic material, which layer is present between a first and a second pattern of electrodes (not shown), which patterns define the display pixel 2 or segment, at least one of the two patterns being transparent to light to be emitted through the active layer, and a first pattern comprising a material which is suitable for injecting charge carriers. The invention is also applicable to segmented displays, backlights, light sources and other light emitting devices using PLED or OLED technology.

Moreover, the display device comprises an area 1¹ with reference pixels 9¹¹. Since the reference pixels 9¹¹ are integrated into the display device itself, more accurate sensing of the temperature of the actual display pixels 2 can be achieved. In FIG. 8 the reference pixels 9¹¹ have been implemented as separate pixels in the vicinity of the display 1. However, it should be appreciated that also specific pixels of the display 1 can be employed, e.g. the display pixels 2′ in the corners of the display 1.

The reference pixels 9¹¹ are preferably of a similar material composition as the display pixels 2. This may depend e.g. on the manufacturing process employed for depositing the active layer. If spin-coating is applied, the material composition of the display pixels 2 and the reference pixels 9¹¹ is similar. If inkjet printing is applied, the material should be suitable for printing, but is not necessarily similar for the materials employed for the display pixels 2 and the reference pixels 9¹¹.

The display pixels 2 can be driven via connections 8 by a display controller 3 in response to a data input signal 4.

In order to monitor the temperature of the display or display pixels 2, a temperature sensor controller 9¹ is employed. The temperature sensor controller 9¹ is connected to the reference pixels 9¹¹ via connections 20 and to the display controller via connection 10. It will be appreciated that the temperature sensor controller 9¹ may be a module of the display controller 3 or other hardware, instead of being a separate unit. The temperature sensor controller 9¹ may be applied for biasing the reference pixels 9¹¹ as well as for measuring or deriving a temperature-dependent characteristic or value of the reference pixels 9¹¹.

The temperature of the display 1 or display pixels 2 is determined by the temperature sensor controller 9¹. Temperature sensor controller 9¹ measures a temperature-dependent characteristic or value of at least one reference pixel 9¹¹ or 2¹. Such a temperature-dependent characteristic or value may relate to electrical data of the reference pixel 9¹¹, such as a current-voltage characteristic. These characteristics are obtained by biasing the reference pixels 9¹¹. A bias current or voltage is applied to the reference pixel 9¹¹ and a resulting voltage or current is measured or derived. In FIG. 9 a schematic representation is shown of a current I versus voltage V characteristic of a reference pixel 9¹¹. It is observed that for a temperature T, a current-voltage characteristic A is obtained that is different from the characteristic B observed at a temperature T₂, wherein in this situation T₂>T₁. Typically, temperatures range from 0 to 80° C. Voltages typically range from −5 to 5 Volt in FIG. 9. The curves may vary in position and form depending on e.g. differences of the supply lines of the reference pixels 9¹¹. The reference pixels 9¹¹ are not controlled by the display controller 3 as they are not meant for display purposes. In fact it is beneficial that the reference pixels 9¹¹ are biased in a temperature measurement state by the temperature sensor controller 9¹. In the temperature measurement state the reference pixel 9¹¹ is biased at a level low enough to prevent, or at least substantially prevent, the reference pixel 9¹¹ from emitting light and high enough to enable a reliable measurement or derivation of the temperature-dependent characteristic or value of the reference pixel as shown in FIG. 9. The temperature sensor controller 9¹ may comprise a unit for converting the measured or derived temperature-dependent characteristic or value into the (operating) temperature of the display pixels 2. Such a unit may be a look-up table wherein the obtained characteristic or value is linked to a temperature. For example, a measurement or derivation of the conductivity of the reference pixels 9¹¹ by the temperature sensor controller 9¹, resulting in the characteristic A as shown in FIG. 9, can be linked to temperature T₁. The values in the look-up table may have been calibrated for disturbing effects such as electrical losses in the connections 20 with the reference pixels 9¹¹ or built-in potentials as a result of the materials applied. An other unit can be used as well such as an analytical function lining a measured or derived temperature-dependent value of a reference pixel 9¹¹ to a temperature of display pixels 2.

The temperature obtained by the temperature sensor controller 9¹ is transmitted to the display controller 3 via connection 10.

The display device shown in FIG. 8 comprises multiple reference pixels 9¹¹. These reference pixels 9¹¹ are preferably distributed so as to cope with temperature gradients over the display device.

Moreover, for color displays a reference pixel 9¹¹ may be employed for at least some of the colors R, G or B employed. This may increase the accuracy of the temperature measurement. The temperature sensor controller 9¹ may need to have an appropriate look-up table to convert the data of the separate reference pixels 9¹¹ into the right temperature.

The reference pixels 9¹¹ are preferably not integrated in the active display area. Instead it may be beneficial to shield the reference pixels 9¹¹ in the area 1 of the display device in order to avoid exposure of these reference pixels 9¹¹ to ambient or environmental light. By shielding the reference pixels 9¹¹ photocurrents can be prevented as well as degradation due to ambient light, improving the accuracy of the temperature measurement or derivation.

The temperature of the reference pixels 9¹¹ may be measured or derived by the temperature sensor controller 9¹ continuously or probed only at specific or periodic times or time intervals. Probing at specific times instead of measuring continuously may be advantageous with regard to the power consumption of the display device. The time intervals for probing may depend on e.g. the correction driving scheme employed. Moreover, if the light emitting layers of the LED are chosen such that the light efficiency does not vary in a predetermined temperature range, the reference pixels 9¹¹ only have to be probed if the burn-in correction has to be determined.

For the purpose of teaching the invention, preferred embodiments of the display device and the electronic device comprising such a display device have been described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Display device for displaying an image comprising a plurality of display pixels (2), the display device comprising: sensors (9; 11; 14) for monitoring operating conditions of the display pixels (2), and a controller (3) coupled to receive data related to the operating conditions from the sensors (9; 11; 14) for determining a brightness change of the pixels (2) caused by the operating conditions, to generate a driving signal (8) for driving the pixels (2) in dependence on the brightness change.

2. Display device according to claim 1, wherein said sensors (9; 11; 14) comprise at least one temperature sensor (9) for monitoring temperature data relating to the pixels (2), monitoring means (5) are present for monitoring total charge data of the pixels (2), and said controller (3) is adapted to generate said driving signal (8) in dependence on the total charge data and the temperature data.

3. Display device according to claim 2, wherein the controller is adapted to derive an acceleration factor from the temperature data and to adjust the driving signal (8) depending on the product of the total charge data and the acceleration factor.

4. Display device according to claim 2, wherein the temperature sensor (9) comprises at least one reference pixel and temperature determination means adapted to determine a temperature in dependence on at least one temperature-dependent characteristic of the reference pixel.

5. Display device according to claim 1, wherein the sensors (9; 11; 14) comprise at least one reference pixel (11), monitoring means (5) are present for monitoring total charge data of the pixels (2), and further monitoring means (13) are present, adapted for determining degradation state data of said reference pixel (11), said controller (3) being adapted to generate said driving signal (8) taking account of said total charge data and said degradation state data

6. Display device according to claim 5, wherein a photodiode is present to measure the degradation state data of said reference pixel (11).

7. Display device according to claim 5, wherein the pixels (2) comprise at least two sub-pixels of a different type, and at least one reference pixel for each type is present.

8. Display device according to claim 5, wherein said controller (3) is adapted to provide each reference pixel (11) with a driving signal corresponding to an average brightness level of the respective types.

9. Display device according to claim 5, wherein said controller (3) is adapted to ignore at least one of the total charge data and the data from the sensors (9; 11; 14) for at least one sub-pixel.

10. Display device according to claim 1, wherein the sensors (9; 11; 14) comprise means (14) to sense a relation between a reverse current and a reverse voltage of the pixels (2) for deriving degradation state data for the pixels (2), and said controller (3) is adapted to generate said driving signal (8) taking account of said degradation state data.

11. Display device according to claim 10, wherein said means (14) are adapted to derive said degradation state data when the display device (1) is turned on.

12. Method of generating a driving signal (8) for driving a plurality of pixels (2) of an organic electroluminescent display device for displaying an image, the device comprising sensors (9; 11; 14) for monitoring operating conditions of the pixels (2);
the method comprising the steps of:
obtaining data from the sensors (9; 11;14) related to the operating conditions;
determining a brightness change of the pixels (2) caused by the operating conditions; and
generating a driving signal (8) in dependence on the brightness change.
